(19) United States
(12) Patent Application Publication
(10) Pub. No.: US 2009/0204613 A1
(43) Pub. Date: Aug. 13, 2009

(54) PATTERN DETECTION APPARATUS, PATTERN DETECTION SYSTEM, PATTERN DETECTION PROGRAM AND PATTERN DETECTION METHOD

(76) Inventor: YASUYUKI MUROI, Tokyo (JP)

Correspondence Address: NEC CORPORATION OF AMERICA, 6535 N. STATE HWY 161, IRVING, TX, 75039, US

(21) Appl. No.: 12/366,781

(22) Filed: Feb. 6, 2009

(30) Foreign Application Priority Data
Feb. 13, 2008 (JP) 31477/2008

(51) Int. Cl. G06F 17/30

(52) U.S. Cl. 707/6; 707/E17.014

(57) ABSTRACT

A pattern detection apparatus includes a pattern DB which stores pattern information corresponding to a file type, a management unit which receives data belonging to a file which is transferred between an information processing apparatus and an external apparatus connected thereto and is divided into the data, and an arithmetic unit which checks whether or not the data include a pattern indicated by the pattern information corresponding to the file type of the file and which reports a check result to be sent to the information processing apparatus.

This application is based upon and claims the benefit of priority from Japanese Patent Application No. 2008-31477, filed on Feb. 13, 2008, the disclosure of which is incorporated herein in its entirety by reference.

### TECHNICAL FIELD

The present invention relates to a pattern detection apparatus, a pattern detection system, a pattern detection program and a pattern detection method.

### BACKGROUND ART

Japanese Patent Application Laid-Open No. 1999-095970 discloses a multi-window display apparatus having a cell pattern corresponding to a window size. Japanese Patent Application Laid-Open No. 1996-328846 discloses a memory storage which is connected to an information processing apparatus, and which performs a virus check of a file stored in a disk. Japanese Patent Application Laid-Open No. 1994-337781 discloses an apparatus which compares pattern data with buffered input data sent to a central processing unit (CPU) to detect a virus. Japanese Patent Application Laid-Open No. 2007-164450 discloses an apparatus which performs a virus check of a file when receiving a request to store the file. Japanese Patent Application Laid-Open No. 2003-169105 discloses an apparatus which monitors continuity of received data based on a sequence number of the received data.

### SUMMARY

An exemplary object of the present invention is to provide a pattern detection apparatus, a pattern detection system, a pattern detection program and a pattern detection method which enable appropriate pattern detection outside an information processing apparatus.

A pattern detection apparatus according to an exemplary aspect of the present invention includes a pattern DB which stores pattern information corresponding to a file type, a management unit which receives data belonging to a file which is transferred between an information processing apparatus and an external apparatus connected thereto and is divided into the data, and an arithmetic unit which checks whether or not the data include a pattern indicated by the pattern information corresponding to the file type of the file and which reports a check result to be sent to the information processing apparatus.

A computer readable medium according to an exemplary aspect of the present invention embodies a program that controls a computer including a pattern DB which stores pattern information corresponding to a file type and causes the computer to perform a pattern detection method. The pattern detection method includes the steps of receiving data belonging to a file which is transferred between an information processing apparatus and an external apparatus connected thereto and is divided into the data, checking whether or not the data include a pattern indicated by the pattern information corresponding to the file type of the file, and reporting a check result to be sent to the information processing apparatus.

In a pattern detection method according to an exemplary aspect of the present invention, a computer including a pattern DB which stores pattern information corresponding to a file type performs receiving data belonging to a file which is transferred between an information processing apparatus and an external apparatus connected thereto and is divided into the data, checking whether or not the data include a pattern indicated by the pattern information corresponding to the file type of the file, and reporting a check result to be sent to the information processing apparatus.

### BRIEF DESCRIPTION OF THE DRAWINGS

Exemplary features and advantages of the present invention will become apparent from the following detailed description when taken with the accompanying drawings in which:

FIG. 1 is a diagram showing a pattern detection system 10 of a first exemplary embodiment of the present invention;

FIG. 2 is a diagram showing details of a pattern detection apparatus 50;

FIG. 3 is a diagram showing details of IO instructions 40;

FIG. 4 is a diagram showing details of a control table 61;

FIG. 5 is a flowchart showing an operation of a management unit 51;

FIG. 6 is a flowchart showing an operation of an arithmetic unit 52;

FIG. 7 is an example of a flowchart of an assumed operation of an OS 31 in an information processing apparatus 30 using the pattern detection apparatus 50;

FIG. 8 is a diagram showing details of IO instructions 40 used by the pattern detection system 10 of a second exemplary embodiment of the present invention;

FIG. 9 is a diagram showing a pattern detection system 10 of a third exemplary embodiment of the present invention;

FIG. 10 is a diagram showing details of a pattern detection apparatus 50 used by a pattern detection system 10 of a fourth exemplary embodiment of the present invention;

FIG. 11 is a flowchart showing operation of an arithmetic unit 52 of the fourth exemplary embodiment; and

FIG. 12 is a diagram showing a pattern detection apparatus 50 of a fifth exemplary embodiment of the present invention.

### EXEMPLARY EMBODIMENT

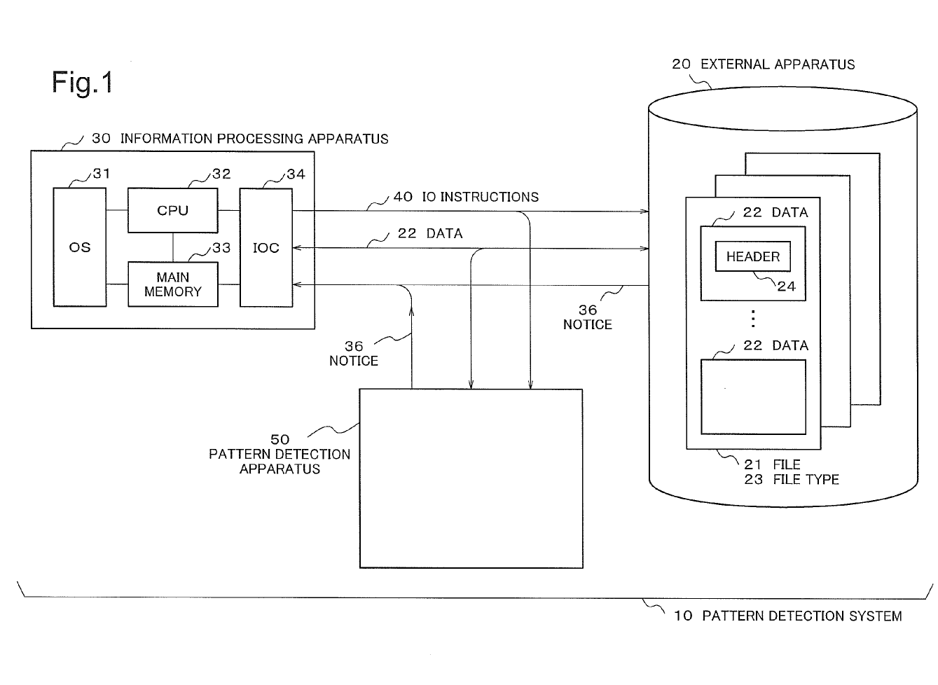

FIG. 1 shows a pattern detection system 10 of a first exemplary embodiment of the present invention. The pattern detection system 10 includes a pattern detection apparatus 50, an information processing apparatus 30 and an external apparatus 20.

The information processing apparatus 30 includes a CPU (Central Processing Unit) 32, a main memory 33, an IOC (Input/Output Controller) 34 and an OS (Operating System) 31.

The external apparatus 20 is an information storage apparatus such as a magnetic disk device, an optical disk device, a semiconductor memory device and the like. The external apparatus 20 stores one or more files 21 classified into a variety of file types 23. A type of the file 21 which the file types 23 indicate includes a document, a spread sheet, an image, music and the like. File 21 includes one or more data 22. The data 22 may include a header 24. The file type 23 can be distinguished by referring to the header 24. The first data 22 in the file 21 usually includes header 24. However, other data 22 may include the header 24. In the following descriptions, the first data 22 in the file 21 includes the header 24.

The OS 31 is carried out by the CPU 32. The OS 31 sends the file 21 to the main memory 33 and outputs the file 21 from the main memory 33. The OS 31 usually divides the file 21 into a plurality of data 22, and then sends and receives the data 22 in series. In this process, the OS 31 prepares a continuous input area which is different from each other for each file 21 that is sent and received in parallel, in the main memory 33. After that, the OS 31 generates a series of IO instructions (Input/Output instructions) 40. The OS 31 sends the IO instructions 40 to the external apparatus 20 and receives the data 22 and various notices 36 from the external apparatus 20 via the IOC 34. The OS 31 may send the data 22 to the external apparatus 20.

The pattern detection apparatus 50 receives the IO instructions 40 and the data 22. The pattern detection apparatus 50 also performs checking whether or not the data 22 include information having a predetermined pattern such as a virus detecting pattern. The pattern detection apparatus 50 reports completion of the checking and a checking result by sending notices 36 to the information processing apparatus 30.

The pattern detection apparatus 50 receives the IO instructions 40 and the data 22, and sends notice 36 to the information processing apparatus 30. The pattern detection apparatus 50 is connected to the information processing apparatus 30, the external apparatus 20, or cables which connect therebetween in order to enable above receiving and sending. A connection port, a cable and a connection method are determined according to input/output interfaces (bus configuration, for example) of the information processing apparatus 30 and the external apparatus 20. Therefore, the connection port, the cable and the connection method are not limited in the exemplary embodiment.

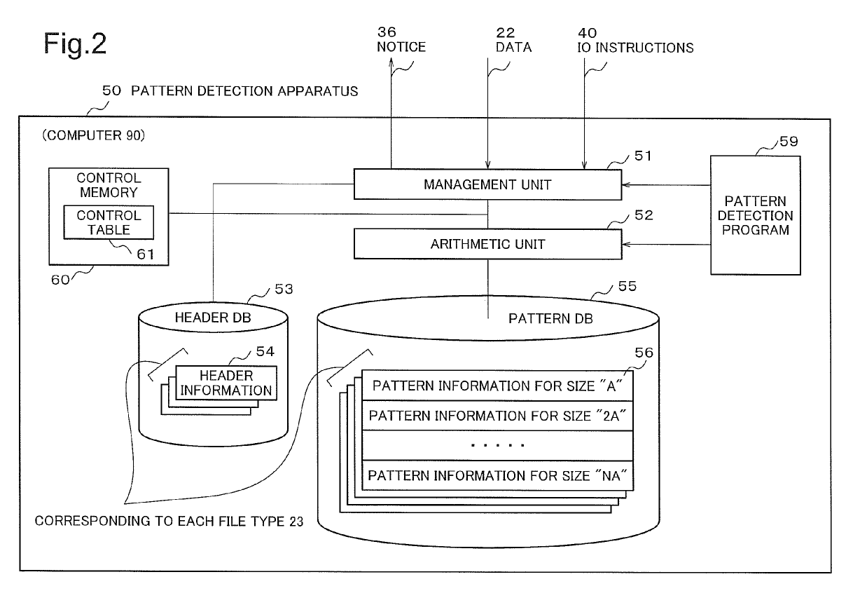

FIG. 2 shows details of the pattern detection apparatus 50. The pattern detection apparatus 50 includes a management unit 51, a control memory 60, an arithmetic unit 52, a header DB (Data Base) 53 and a pattern DB 55.

The management unit 51 and the arithmetic unit 52 may be implemented as hardware. Alternatively, the management unit 51 and the arithmetic unit 52 may be implemented as software which the pattern detection apparatus 50 that is a computer 90 executes. More specifically, the management unit 51 and the arithmetic unit 52 may be implemented so as to function when a processor (not shown) executes a pattern detection program 59 which is stored in a memory (not shown).

The control memory 60 is a storage area accessed from both of the management unit 51 and the arithmetic unit 52. The control memory 60 stores a control table 61. The header DB 53 is a storage area accessed from the management unit 51. The header DB 53 stores header information 54. Each file type 23 includes one or more pieces of header information 54. The header information 54 is information specific to file type 23 which is extracted from the header 24.

The pattern DB 55 is a storage area accessed from the arithmetic unit 52. The pattern DB 55 stores pattern information 56. The pattern information 56 exists corresponding to each file type 23. However, the pattern information 56 corresponding to a certain file type 23 may not exist. The pattern information 56 is divided into entries corresponding to a size of target data of pattern detection. The target data of pattern detection is single data 22 or data 22 in which a plurality of data 22 is combined. An entry of the pattern information 56 corresponding to a certain size may not exist. Also, a plurality of entries of the pattern information 56 corresponding to the same size may exist.

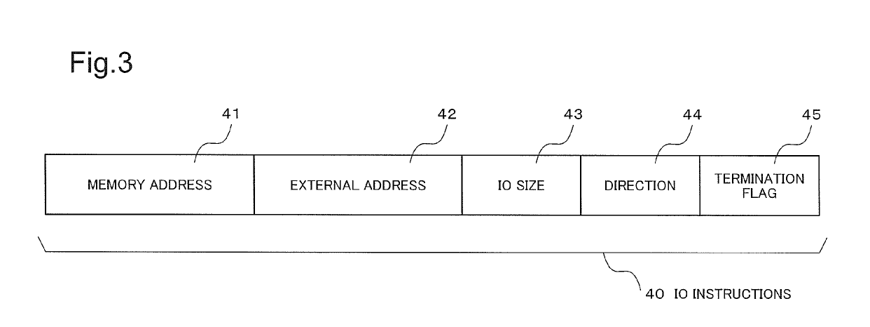

FIG. 3 shows details of the IO instructions 40. The IO instructions 40 include a memory address 41, an external address 42, an IO size 43, direction 44 and a termination flag 45.

The memory address 41 indicates the first address of an area in the main memory 33 which receives the data 22 or sends the data 22. The external address 42 indicates an identifier of the external apparatus 20 which receives the data 22 or sends the data 22 and indicates a storage area address (e.g. a block number) in the external apparatus 20. The IO size 43 indicates size of the data 22 (e.g. the number of bytes) transferred according to the IO instructions 40. The direction 44 indicates input (reading) or output (writing).

Termination flag 45 indicates the end of a series of the IO instructions 40 with respect to a certain file 21. When receiving and outputting the file 21, the information processing apparatus 30 often receives and outputs the file 21 with a divided form. The reason is that the data 22 belonging to a certain file 21 is not necessarily recorded continuously in the external apparatus 20. Another reason is that a ceiling is put on the size of the data 22 that can be transferred together. In other words, when receiving and outputting a certain file 21, the information processing apparatus 30 often outputs a plurality of the IO instructions 40. The termination flag 45 indicates whether the IO instruction 40 is the last one of the IO instructions 40 in divided input and output. During receiving and outputting of a certain file 21, when only one IO instruction 40 is outputted, the termination flag 45 of the IO instruction 40 indicates the last IO instruction 40.

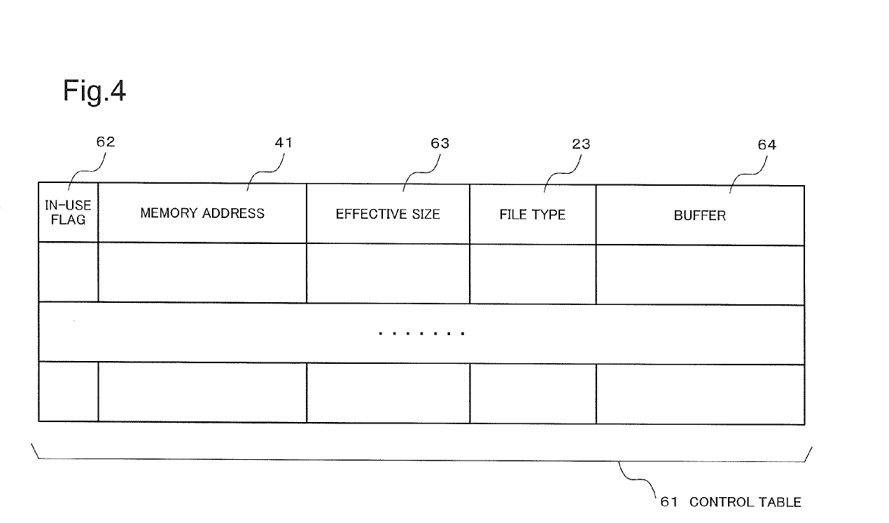

FIG. 4 indicates details of the control table 61. The control table 61 includes a plurality of entries. Each entry includes an in-use flag 62, a memory address 41, an effective size 63, a file type 23 and a buffer 64.

The in-use flag 62 indicates whether the entry is “vacant” or “in use”. When being “in use”, the entry is used for one file 21. The buffer 64 stores one or more data 22 in the file 21 from the head in series (in a combined manner). The effective size 63 indicates the total size (the number of bytes, for example) of the data 22 stored in the buffer 64.

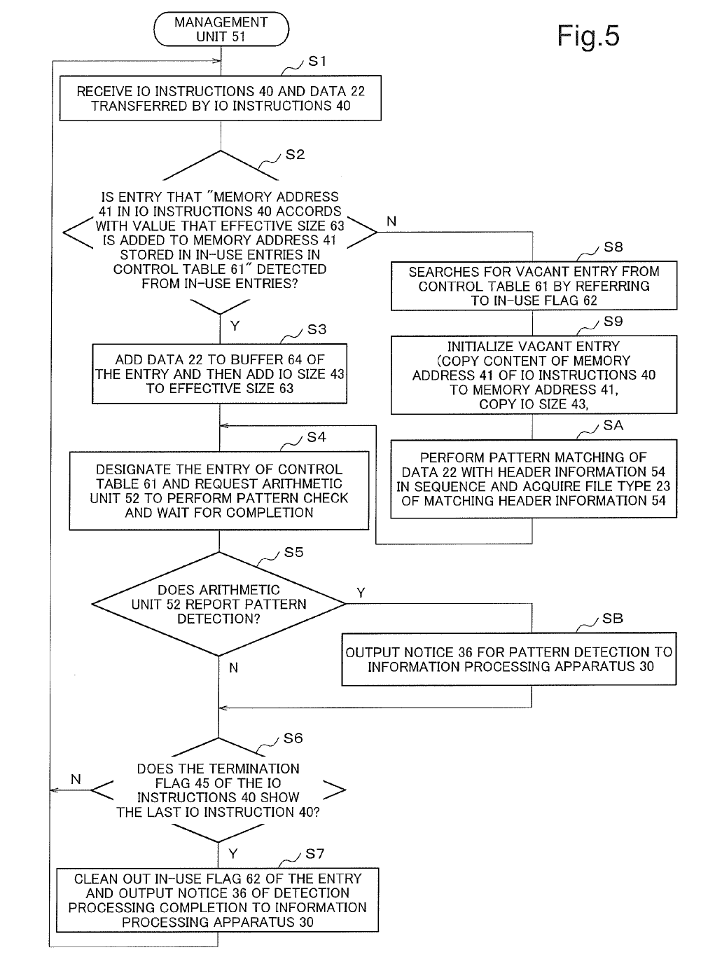

FIG. 5 is a flowchart showing operations of the management unit 51.

The management unit 51 receives the IO instructions 40 and the data 22 transferred according to the IO instructions 40 (S1). The management unit 51 recognizes a corresponding relationship between the IO instructions 40 and the data 22 depending on input/output interfaces of the information processing apparatus 30 and the external apparatus 20. For example, when issuance of the IO instructions 40 and transfer of the data 22 corresponding thereto is carried out sequentially, the management unit 51 recognizes a corresponding relationship between the IO instructions 40 and the data 22 based on time series to which the IO instructions 40 and the data 22 are inputted. When issuance of a plurality of IO instructions 40 and transfer of the data 22 corresponding thereto are performed in parallel, the management unit 51 recognizes the corresponding relationship between the IO instructions 40 and the data 22 by the same method as the IOC 34 does. More specifically in the latter case, for example, the management unit 51 recognizes the corresponding relationship between the IO instructions 40 and the data 22 by judging identity of common identification information (such as an IO issuance identifier, a memory address 41 or an address related to the external apparatus 20) which is attached to both of corresponding IO instructions 40 and data 22.

The management unit 51 searches for an entry from in-use entries of the control table 61 for which “the memory address 41 in the IO instructions 40 is identical with the value that the effective size 63 is added to the memory address 41 stored in the entry.”

When the search is performed (Y at S2, that is, at the time of continuous input/output of file 21), the management unit 51 adds the data 22 to the buffer 64 of the entry and then adds the IO size 43 to the effective size 63 (S3). Here, the adding of the data 22 means creating the data 22 that the data 22 which is already stored in the buffer 64 and the data 22 to be added are combined by storing the data 22 in an area of the buffer 64 next to an area corresponding to the effective size 63. After that, the management unit 51 designates the entry of the control table 61 and requests the arithmetic unit 52 to perform pattern check for the entry. The management unit 51 waits for the completion (S4).

When the search is not performed (N at S2, that is, at the time of beginning of input/output of a new file 21), the management unit 51 searches for a vacant entry from control table 61 by referring to the in-use flag 62 (S8). When the vacant entry is found, the management unit 51 initializes the vacant entry (S9). Specifically, the management unit 51 performs operations below.

1) Setting the in-use flag 62 into “in use”.

2) Copying contents of the memory address 41 of the IO instructions 40 to the memory address 41.

3) Copying the IO size 43 to the effective size 63.

4) Storing the data 22 on the beginning of the buffer 64.

Next, the management unit 51 performs pattern matching of the data 22 and the header information 54 in sequence and acquires the file type 23 of the header information 54 corresponding to the data 22 (SA). Because the data 22 is beginning data 22 of the file 21, the data 22 includes the header 24. Further, when the header 24 is not included in the beginning data 22 of the file 21, the data 22 including the header 24 is recognized by a method specific to the file 21, and then the pattern matching is performed. The specific method includes recognition of the last data 22 and recognition of data 22 with specific order, for example.

After that, the management unit 51 designates the initialized entry of the control table 61 and requests the arithmetic unit 52 to perform pattern check for the entry. The management unit 51 waits for completion thereof (S4).

When it is reported from the arithmetic unit 52 that no pattern is detected (N at S5), the management unit 51 checks the termination flag 45 of the IO instructions 40 (S6). On the other hand, when it is reported from the arithmetic unit 52 that a pattern is detected (Y at S5), the management unit 51 outputs notice 36 that a pattern is detected to the information processing apparatus 30 (SB). At that time, the management unit 51 adds identification information of the pattern information 56 that matching of a pattern is detected and the file type 23 to the notice 36. Meanwhile, notice 36 of the pattern detection may be directly outputted by the arithmetic unit 52 without going through the management unit 51. After the notice 36 is outputted, the management unit 51 checks the termination flag 45 of the IO instructions 40 (S6).

When the termination flag 45 does not indicate the last IO instruction 40 of the file 21 (N at S6), the management unit 51 performs processing of the next IO instruction 40 and the data 22 (S1). When the termination flag 45 indicates the last IO instruction 40 of the file 21 (Y at S6), the management unit 51 changes the in-use flag 62 into “vacant”, and then outputs notice 36 of detection processing completion to the information processing apparatus 30 (S7). After that, the management unit 51 performs processing of the next IO instruction 40 and data 22 (S1).

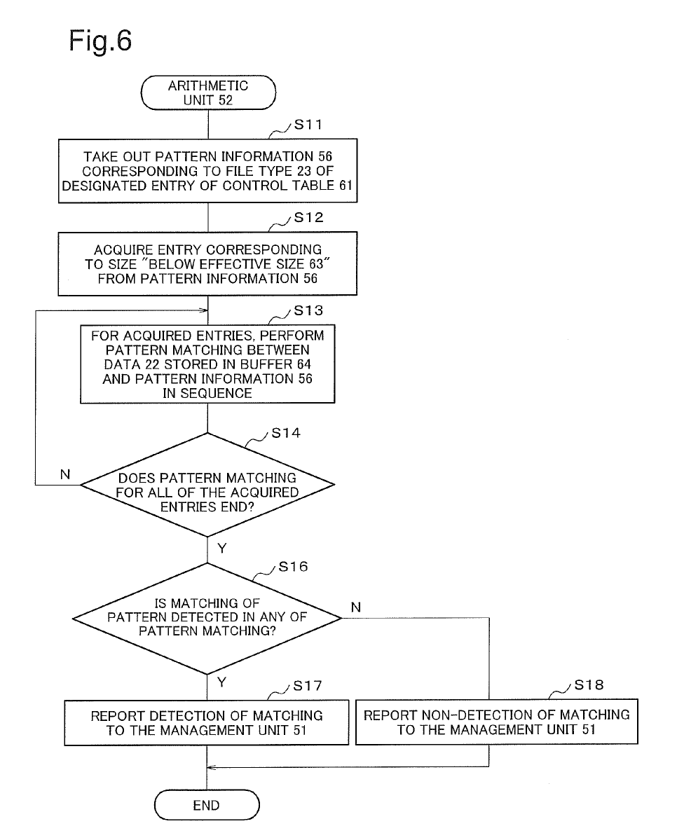

FIG. 6 is a flowchart showing operations of the arithmetic unit 52.

Being required to detect a pattern from the management unit 51, the arithmetic unit 52 refers to an entry of the control table 61 designated by the management unit 51. The arithmetic unit 52 takes out the pattern information 56 corresponding to the file type 23 of the entry from the pattern DB 55 (S11).

The arithmetic unit 52 acquires an entry corresponding to a size “below the effective size 63” from the pattern information 56 (S12). A plurality of entries of the pattern information 56 corresponding to the size may be acquired, and meanwhile none of such entries may be acquired.

With respect to the acquired entries of the pattern information 56, the arithmetic unit 52 performs pattern matching with the data 22 stored in the buffer 64, in sequence (S13). Here, the data 22 is either the single data 22 or the combined data 22. The size thereof is indicated by the effective size 63.

When pattern matching for all of the acquired entries ends (Y at S14) and matching of a pattern is detected during any one of the pattern matching sessions (Y at S16), the arithmetic unit 52 reports detection of a pattern to the management unit 51 (S17). At that time, the arithmetic unit 52 reports along with identification information (the address of the entry in the pattern DB 55, for example) and file type 23 and the like of the entry of the pattern information 56 that matching is detected. When matching of a pattern is not detected in pattern matching sessions (N at S16), the arithmetic unit 52 reports non-detection of matching to the management unit 51 (S18).

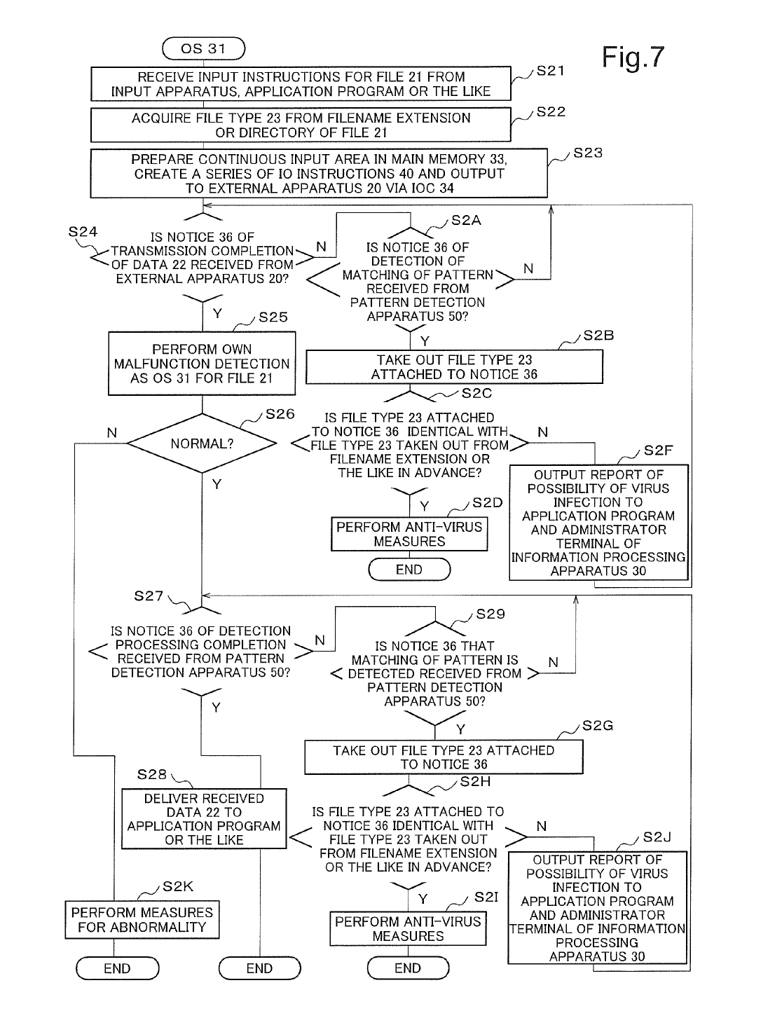

FIG. 7 is an example of an assumed operation flowchart of the OS 31 in the information processing apparatus 30 which uses the pattern detection apparatus 50. Here, it is supposed that the pattern information 56 is information for detecting a virus which may infect the file 21. That is, the pattern detection apparatus 50 functions as a virus detector.

When receiving input instructions including the name of the file 21 or the like from an input apparatus, an application program or the like (S21), the OS 31 acquires the file type 23 from a filename extension, a directory of the file 21 or the like (S22).

Next, the OS 31 prepares a continuous input area in the main memory 33. Then, the OS 31 creates a series of IO instructions 40 and outputs those to the external apparatus 20 via the IOC 34 (S23). As a result, transfer of the data 22 from the external apparatus 20 to the IOC 34 starts. The data 22 is transferred to the IOC 34, is also inputted to the pattern detection apparatus 50 and is accumulated in the buffer 64. The pattern detection apparatus 50 performs virus detection for the data 22 accumulated in the buffer 64 using the pattern information 56 in sequence.

When notice 36 of transmission completion of the data 22 arrives from the external apparatus 20 (Y at S24), the OS 31 may perform specific malfunction detection thereof for the inputted file 21 (S25). That is because an effective malfunction detection method for the file 21 besides the detection method using the pattern information 56 may be possible. For example, an alteration detection method using digital signature is possible. Further, a virus detection method using a pattern which is different from a pattern used in the pattern detection apparatus 50, and a virus detection method based on a different viewpoint from the pattern detection apparatus 50 can be utilized.

Here, when normal status is confirmed (Y at S26), the OS 31 waits for notice 36 of detection processing completion from the pattern detection apparatus 50. When receiving notice 36 of the detection processing completion (Y at S27) the OS 31 hands over the inputted data 22 to an application program and the like (S28) to finish the processing. When abnormality is detected (N at S26), the OS 31 performs appropriate measures to the abnormality (S2K) to finish the processing. The measures include disposal of the input data 22 or output of a failure report to an application program and/or an administrator terminal of the information processing apparatus 30, for example.

When the OS 31 receives notice 36 that matching of a pattern is detected (Y at S29) while waiting for notice 36 of detection processing completion from the pattern detection apparatus 50 (N at S27), the OS 31 takes out the file type 23 attached to the notice 36 (S2G).

The OS 31 compares the file type 23 attached to the notice 36 with the file type 23 taken out from the filename extension or the like in advance. If the file types 23 are identical (Y at S2H), the OS 31 performs anti-virus measures (S2I) and finishes processing. The virus measures include disposal of the input data 22 and failure report output to the application program or the administrator terminal of the information processing apparatus 30, for example. When the file types are different from each other (N at S2H), the OS 31 outputs a report of possibility of virus infection to the application program and the administrator terminal of the information processing apparatus 30 (S2J), and then continues processing. The reason is that, in this case, presence of virus infection cannot be determined because the pattern detection apparatus 50 wrongly recognizes the file type 23.

Upon receipt of notice 36 that matching of a pattern is detected (Y at S2A) while waiting for notice 36 of transfer completion of the data 22 from the external apparatus 20 (N at S24), the OS 31 takes out the file type 23 attached to the notice 36 (S2B).

The OS 31 compares the file type 23 attached to the notice 36 with the file type 23 taken out from the filename extension or the like in advance. If the file types 23 are identical (Y at S2C), the OS 31 performs anti-virus measures (S2D) and finishes processing. When the file types 23 are different from each other (N at S2C), the OS 31 outputs a report of possibility of virus infection to the application program and the administrator terminal of the information processing apparatus 30 (S2F) and then continues processing.

Meanwhile, a component other than the OS 31 can be a source of a request for sending the file 21. A program (e.g. initial program loader, boot program) for loading the OS 31 may be the source of a request for sending the file 21.

According to the exemplary embodiment, the pattern detection system 10 can perform pattern check (e.g. virus check) without widely increasing load of the information processing apparatus 30. The pattern detection system 10 can perform the pattern check for the component file 21 of the OS 31 or the like before start of the OS 31. The reason is that the pattern detection apparatus 50 receives the data 22 to perform pattern detection separately from the information processing apparatus 30.

According to the exemplary embodiment, the pattern detection system 10 can perform pattern check appropriately. The reason is that the pattern detection apparatus 50 receives the data 22, recognizes the file type 23, and performs pattern check using the pattern information 56 suitable for the file type 23.

According to the exemplary embodiment, the pattern detection system 10 can perform pattern check quickly. The reason is that the pattern detection apparatus 50 accumulates the data 22 in sequence, and performs pattern check using the pattern information 56 that can be applied to the effective size 63 of the accumulated data 22 even in process of transfer of the file 21.

According to the exemplary embodiment, the pattern detection system 10 can perform pattern check safely. The reason is that the file type 23 that the pattern detection apparatus 50 recognizes from the data 22 is reported to the information processing apparatus 30. That is, the OS 31 can verify the file type 23 that the pattern detection apparatus 50 recognizes.

According to the exemplary embodiment, the pattern detection system 10 can distribute load of pattern detection appropriately to the information processing apparatus 30 and the pattern detection apparatus 50. The reason is that the pattern detection apparatus 50 reports completion of detection processing of a pattern separately from a report of transfer completion of the data 22. Until the transfer completion report and the detection processing completion, the OS 31 and the pattern detection apparatus 50 can perform detection of a pattern in parallel.

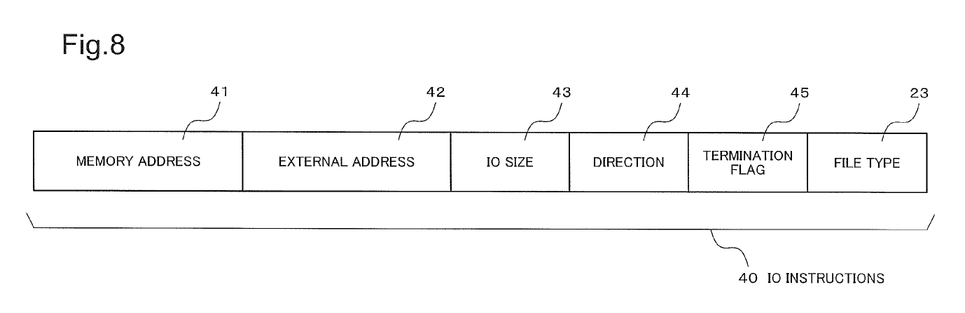

FIG. 8 indicates details of the IO instructions 40 used by the pattern detection system 10 of a second exemplary embodiment of the present invention. The IO instructions 40 of the second exemplary embodiment include the file type 23. That is, when the IO instructions 40 is created, the OS 31 adds the file type 23 that the OS 31 acquires from the filename extension, a directory or the like of the file 21 in the IO instructions 40 (S21 and S22 of FIG. 7).

The management unit 51 of the second exemplary embodiment is different from the first exemplary embodiment with respect to the operation SA in FIG. 5. That is, in the second exemplary embodiment, the management unit 51 of the pattern detection apparatus 50 acquires the file type 23 not from the inputted data 22 but from the IO instructions 40. Accordingly, the pattern detection apparatus 50 does not need to have the header DB 53. The second exemplary embodiment is the same as the first exemplary embodiment in the other points.

In the second exemplary embodiment, the pattern detection apparatus 50 has no possibility to wrongly recognize the file type 23. The reason is that the OS 31 provides the file type 23 to the pattern detection apparatus 50.

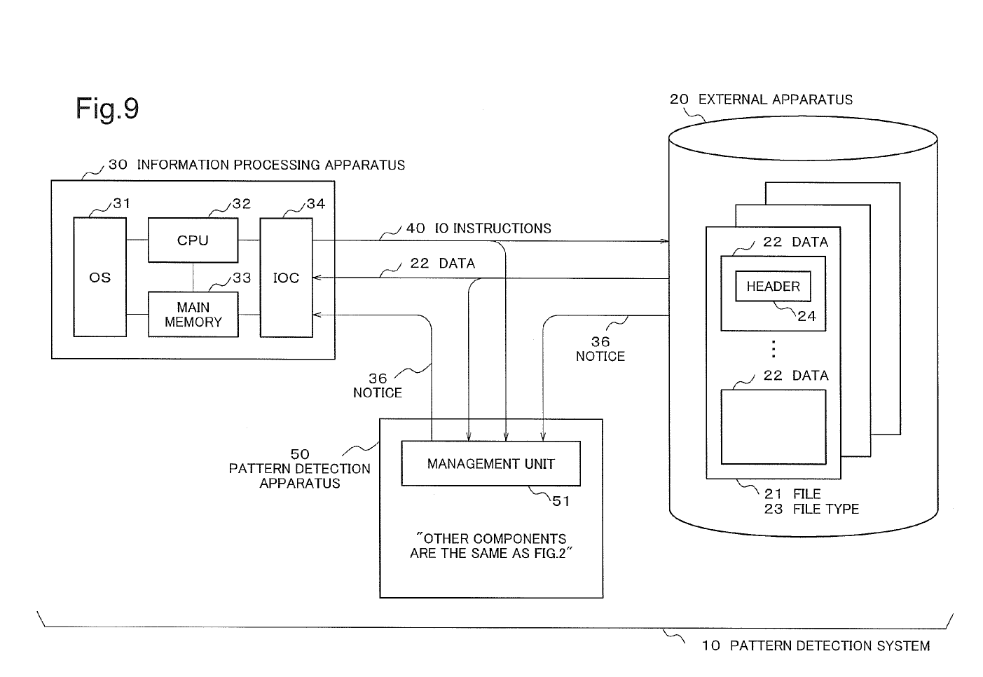

FIG. 9 indicates a pattern detection system 10 of a third exemplary embodiment of the present invention. The pattern detection system 10 of the third exemplary embodiment is different from the first exemplary embodiment with respect that notice 36 from the external apparatus 20 does not reach the information processing apparatus 30 directly but reaches the apparatus 30 via the management unit 51 of the pattern detection apparatus 50.

In the third exemplary embodiment, even if notice 36 of the transmission completion of the data 22 is received from the external apparatus 20, the management unit 51 does not transfer the notice 36 to the information processing apparatus 30 immediately. The management unit 51 waits for completion of pattern detection processing in the arithmetic unit 52, and after the completion, transfers the notice 36 of transfer completion to the information processing apparatus 30.

When a pattern is detected, the file type 23 and identification information on the pattern information 56 are added to the notice 36 of transfer completion. Meanwhile, when receiving notice 36 other than the notice 36 of transfer completion of the data 22 from the external apparatus 20, the management unit 51 transfers that to the information processing apparatus 30 immediately.

In the third exemplary embodiment, the information processing apparatus 30 can minimize change of interface with the external apparatus 20 associated with introduction of the pattern detection apparatus 50. The reason is that the pattern detection apparatus 50 reports notice 36 of completion of pattern detection processing thereof along with notice 36 of transmission completion of the external apparatus 20 to the information processing apparatus 30.

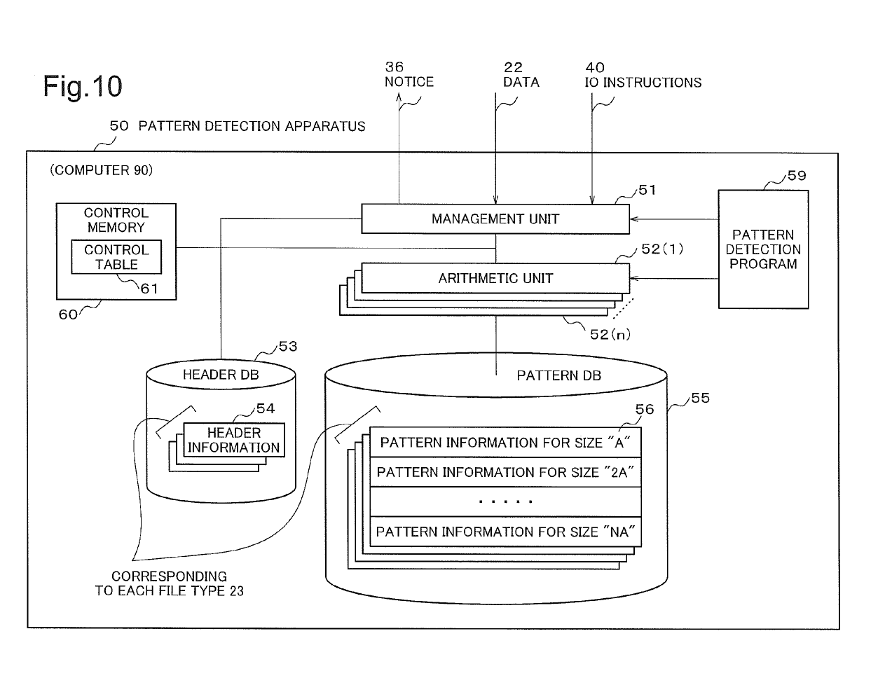

FIG. 10 indicates details of a pattern detection apparatus 50 used in a pattern detection system 10 of a fourth exemplary embodiment of the present invention. In the fourth exemplary embodiment, a plurality of arithmetic units 52 exists. Each arithmetic unit 52 can operate in parallel. In the following descriptions, each arithmetic unit 52 is referred to by putting a parenthetic number (for example, an arithmetic unit 52 (1)).

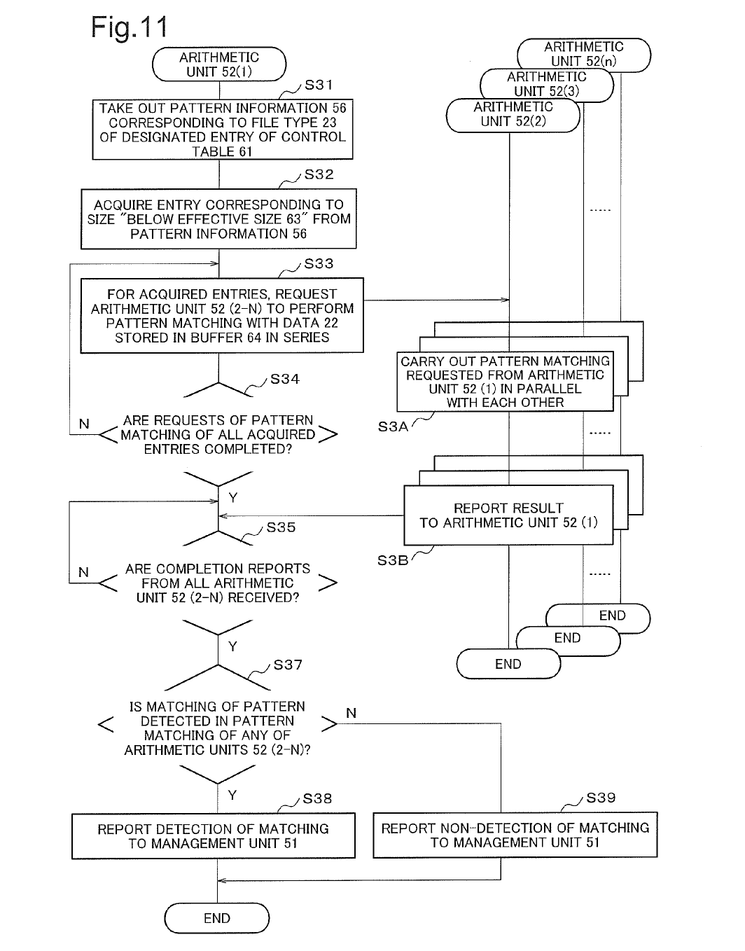

FIG. 11 is a flowchart showing operation of the arithmetic unit 52 of the fourth exemplary embodiment.

When pattern check is requested from the management unit 51, the arithmetic unit 52 (1) refers to an entry of the control table 61 designated by the management unit 51. Pattern information 56 corresponding to the file type 23 of the entry is taken out from the pattern DB 55 (S31).

The arithmetic unit 52 (1) acquires an entry corresponding to size “below the effective size 63” from the pattern information 56 (S32). A plurality of entries of the pattern information 56 corresponding to the size may be acquired, or none of such entry may be acquired.

The arithmetic unit 52 (1) requests the other arithmetic units 52 (2-n) to perform pattern matching for the acquired entries and the data 22 stored in the buffer 64 (S33). That is, when a plurality of entries is acquired from the pattern information 56, the arithmetic unit 52 (1) requests other arithmetic units (2-n) to perform pattern matching for each of the acquired entries of the pattern information 56. Here, the data 22 is single data 22 or combined data 22. Size of the data is indicated by the effective size 63.

When requests of pattern matching of all of the acquired entries are completed (Y at S34), the arithmetic unit 52 (1) waits for completion reports from all the other arithmetic units 52 (2-n) (N at S35). When receiving all completion reports (in S35, Y) and detecting matching of a pattern in pattern matching in any one of the arithmetic units 52 (2-n) (Y at S37), the arithmetic unit 52 (1) reports the detection to the management unit 51 (S38). At that time, the arithmetic unit 52 (1) attaches identification information and the file type 23 of the entry of pattern information 56 to which matching is detected to the report. Meanwhile, when matching of a pattern is not detected in pattern matching (N at S37), the arithmetic unit 52 (1) reports non-detection of matching to the management unit 51 (S39).

Each of the arithmetic units 52 (2-n) carries out pattern matching requested from the arithmetic unit 52 (1) in parallel (S3A). The arithmetic units 52 (2-n) report results of pattern matching to the arithmetic unit 52 (1) (S3B).

The other points of the fourth exemplary embodiment correspond to those of the first exemplary embodiment.

According to the fourth exemplary embodiment, the pattern detection system 10 can perform pattern check at high speed. The reason is that the pattern detection apparatus 50 includes a plurality of arithmetic units 52, and the arithmetic units 52 operate in parallel.

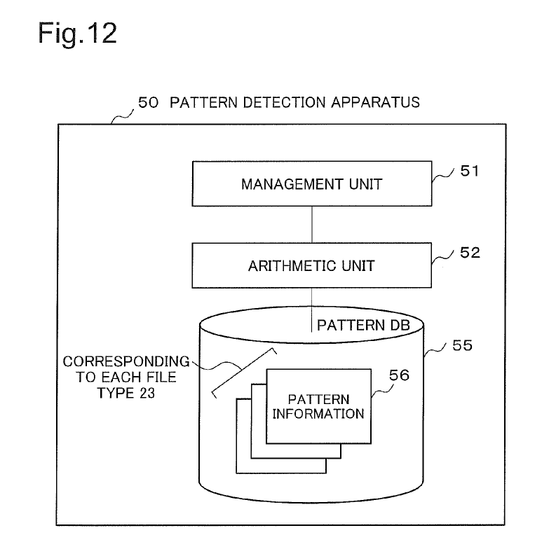

FIG. 12 indicates a pattern detection apparatus 50 of a fifth exemplary embodiment of the present invention. The pattern detection apparatus 50 includes the pattern DB 55 that stores the pattern information 56 corresponding to the file type 23, the management unit 51 and the arithmetic unit 52. The management unit 51 receives the data 22 belonging to the file 21 which is divided into the data 22 and which is transferred between the information processing apparatus 30 and the external apparatus 20 connected thereto. The arithmetic unit 52 checks whether or not the data 22 includes a pattern indicated by the pattern information 56 corresponding to the file type 23 of the file 21. Then, the arithmetic unit 52 reports a check result to be sent to the information processing apparatus 30 as notice 36.

According to the fifth exemplary embodiment, the pattern detection apparatus 50 can perform pattern check appropriately outside the information processing apparatus 30. The reason is that the pattern detection apparatus 50 receives the data 22 inputted to and outputted from the information processing apparatus 30, and performs the pattern check using the pattern information 56 suitable for the file type 23.

Neither of patent documents described in the background art relates to a pattern detection apparatus which checks whether or not a predetermined pattern corresponding to a file type is included in a part of data of a file transferred between an information processing apparatus and an external apparatus to notify the information processing apparatus. Accordingly, there is a problem that appropriate pattern detection cannot be performed without increasing load in the information processing apparatus significantly.

According to the present invention, the information processing apparatus can perform appropriate pattern detection without increasing load significantly.

The previous description of embodiments is provided to enable a person skilled in the art to make and use the present invention. Moreover, various modifications to these exemplary embodiments will be readily apparent to those skilled in the art, and the generic principles and specific examples defined herein may be applied to other embodiments without the use of inventive faculty. Therefore, the present invention is not intended to be limited to the exemplary embodiments described herein but is to be accorded the widest scope as defined by the limitations of the claims and equivalents.

Further, it is noted that the inventor's intent is to retain all equivalents of the claimed invention even if the claims are amended during prosecution.

What is claimed is:

1. A pattern detection apparatus, comprising:
a pattern DB which stores pattern information corresponding to a file type;
a management unit which receives data belonging to a file, said file being transferred between an information processing apparatus and an external apparatus connected thereto and said file being divided into said data; and
an arithmetic unit which checks whether or not said data include a pattern indicated by said pattern information corresponding to said file type of said file, and which reports a check result to be sent to said information processing apparatus.

2. The pattern detection apparatus according to claim 1, wherein
said management unit acquires said file type from said data.

3. The pattern detection apparatus according to claim 2, wherein
said management unit notifies said information processing apparatus of said file type.

4. The pattern detection apparatus according to claim 1, wherein
said management unit acquires said file type from said information processing apparatus.

5. The pattern detection apparatus according to claim 1, wherein
said pattern DB stores first said pattern information corresponding to size of first and second said data and stores second said pattern information corresponding to size of combination data in which said first and said second said data are combined, and
said arithmetic unit carries out checking whether or not said first said data include said pattern indicated by said first said pattern information and checks whether or not said pattern indicated by said first or said second said pattern information is included in said combination data in which said first said data and said second said data are combined, said second said data being added after said checking.

6. The pattern detection apparatus according to claim 5, wherein
said management unit receives first and second IO instructions outputted by said information processing apparatus and receives said first and said second said data, said first said data corresponding to said first IO instructions, said second said data corresponding to said second IO instructions, and
said arithmetic unit determines whether or not said second said data is continuous with said first said data based on a memory address of said information processing apparatus indicated by said first and said second IO instructions, and generates said combination data from said first and said second said data when said second said data is continuous with said first said data.

7. A pattern detection system, comprising: a pattern detection apparatus according to claim 1; said information processing apparatus; and said external apparatus.

8. A computer readable medium embodying a program, said program to control a computer including a pattern DB which stores pattern information corresponding to a file type, said program causing said computer to perform a pattern detection method, said method comprising the steps of:
receiving data belonging to a file which is transferred between an information processing apparatus and an external apparatus connected thereto, said file being divided into said data;
checking whether or not said data include a pattern indicated by said pattern information corresponding to said file type of said file; and
reporting a check result to be sent to said information processing apparatus.

9. The computer readable medium embodying a program according to claim 8, said program causing said computer to perform a said method, wherein
said computer acquires said file type from said data.

10. The computer readable medium embodying a program according to claim 9, said program causing said computer to perform a said method, wherein
said computer notifies said information processing apparatus of said file type.

11. The computer readable medium embodying a program according to claim 8, said program causing said computer to perform a said method, wherein
said computer acquires said file type from said information processing apparatus.

12. The computer readable medium embodying a program according to claim 8, said program to control said computer including a pattern DB which stores first said pattern information corresponding to size of first and second said data and second said pattern information corresponding to said size of combination data in which said first and said second said data are combined, said program causing said computer to perform a said method, said method further comprising the steps of:
carrying out checking whether or not said first said data include said pattern indicated by said first said pattern information;
generating said combination data by combining said first said data and said second said data which are added after said checking; and
checking whether or not said combination data include said pattern indicated by said first or said second said pattern information.

13. The computer readable medium embodying a program according to claim 12, said program causing said computer to perform a said method, said method further comprising the steps of:
receiving first and second IO instructions outputted by said information processing apparatus and said first and said second said data, said first said data corresponding to said first IO instructions, said second said data corresponding to said second IO instructions;
determining whether or not said second said data is continuous with said first said data based on a memory address of said information processing apparatus indicated by said first and said second IO instructions; and
generating said combination data from said first and said second said data when said second said data is continuous with said first said data.

14. A pattern detection method, wherein
a computer including a pattern DB which stores pattern information corresponding to a file type, performs
receiving data belonging to a file which is transferred between an information processing apparatus and an external apparatus connected thereto, said file being divided into said data;
checking whether or not said data include a pattern indicated by said pattern information corresponding to said file type of said file; and
reporting a check result to be sent to said information processing apparatus.

15. The pattern detection method according to claim 14, wherein
said computer acquires said file type from said data.

16. The pattern detection method according to claim 15, wherein
said computer notifies said information processing apparatus of said file type.

17. The pattern detection method according to claim 14, wherein
said computer acquires said file type from said information processing apparatus.

18. The pattern detection method according to claim 14, wherein
said computer including a pattern DB which stores first said pattern information corresponding to size of first and second said data and second said pattern information corresponding to said size of combination data in which said first and said second said data are combined, performs
carrying out checking whether or not said first said data include said pattern indicated by said first said pattern information;
generating said combination data by combining said first said data and said second said data which are added after said checking; and
checking whether or not said combination data include said pattern indicated by said first or said second said pattern information.

19. The pattern detection method according to claim 18, wherein
said computer further performs
receiving first and second IO instructions outputted by said information processing apparatus and said first and said second said data, said first said data corresponding to said first IO instructions, said second said data corresponding to said second IO instructions;
determining whether or not said second said data is continuous with said first said data based on a memory address of said information processing apparatus indicated by said first and said second IO instructions; and
generating said combination data from said first and said second said data when said second said data is continuous with said first said data.

20. A pattern detection apparatus, comprising:
pattern storage means for storing pattern information corresponding to a file type;
management means for receiving said data belonging to a file, said file being transferred between an information processing apparatus and an external apparatus connected thereto and said file being divided into said data; and
arithmetic processing means for checking whether or not said data include a pattern indicated by said pattern information corresponding to said file type of said file, and for reporting a check result to be sent to said information processing apparatus.
